(19) United States
(12) Patent Application Publication
(10) Pub. No.: US 2012/0091021 A1
(43) Pub. Date: Apr. 19, 2012

(54) CARTON WITH REINFORCED TOP PANEL

(76) Inventor: Brian Smalley, Bristol (GB)

(21) Appl. No.: 13/268,264

(22) Filed: Oct. 7, 2011

Related U.S. Application Data
(60) Provisional application No. 61/455,181, filed on Oct. 15, 2010.

(51) Int. Cl. B65D 5/42; B65D 5/50; B31B 1/26; B31B 7/00; B31B 1/02; B65D 5/468; B31B 1/86

(52) U.S. Cl. 206/427; 220/62; 220/628; 220/770; 229/117.15; 229/166; 229/172; 493/88; 493/89; 493/122; 493/162

(57) ABSTRACT

A carton for holding a plurality of containers. The carton comprises a plurality of panels extending at least partially around an interior of the carton, the plurality of panels comprising a bottom panel, a first side panel foldably connected to the bottom panel, a top panel foldably connected to the first side panel, a second side panel foldably connected to the bottom panel, and a reinforcement panel foldably connected to the second side panel. The top panel can at least partially overlap the reinforcement panel. A reinforcement side flap can be foldably connected to the reinforcement panel, and an inner top reinforcement flap can be foldably connected to the reinforcement panel. The reinforcement panel can at least partially overlap the inner top reinforcement flap.

### CROSS-REFERENCE TO RELATED APPLICATIONS

This application claims the benefit of U.S. Provisional Patent Application No. 61/455,181, filed Oct. 15, 2010.

### INCORPORATION BY REFERENCE

The disclosure of U.S. Provisional Patent Application No. 61/455,181, which was filed on Oct. 15, 2010, is hereby incorporated by reference for all purposes as if presented herein in its entirety.

### BACKGROUND OF THE DISCLOSURE

The present disclosure generally relates to cartons for holding beverage containers or other types of articles. More specifically, the present disclosure relates to cartons having a reinforced top panel.

### SUMMARY OF THE DISCLOSURE

In general, one aspect of the disclosure is generally directed to a carton for holding a plurality of containers. The carton comprises a plurality of panels extending at least partially around an interior of the carton, the plurality of panels comprising a bottom panel, a first side panel foldably connected to the bottom panel, a top panel foldably connected to the first side panel, a second side panel foldably connected to the bottom panel, and a reinforcement panel foldably connected to the second side panel. The top panel can at least partially overlap the reinforcement panel. A reinforcement side flap can be foldably connected to the reinforcement panel, and an inner top reinforcement flap can be foldably connected to the reinforcement panel. The reinforcement panel can at least partially overlap the inner top reinforcement flap.

In another aspect, the disclosure is generally directed to a blank for forming a carton. The blank can comprise a plurality of panels comprising a bottom panel, a first side panel foldably connected to the bottom panel, a top panel foldably connected to the first side panel, a second side panel foldably connected to the bottom panel, and a reinforcement panel foldably connected to the second side panel. The top panel can at least partially overlap the reinforcement panel in the carton formed from the blank. A reinforcement side flap can be foldably connected to the reinforcement panel, and an inner top reinforcement flap can be foldably connected to the reinforcement panel. The reinforcement panel can at least partially overlap the inner top reinforcement flap when the carton is formed from the blank.

In another aspect, the disclosure is generally directed to a method of forming a carton. The method can comprise obtaining a blank comprising a plurality of panels comprising a bottom panel, a first side panel foldably connected to the bottom panel, a top panel foldably connected to the first side panel, a second side panel foldably connected to the bottom panel, and a reinforcement panel foldably connected to the second side panel. A reinforcement side flap can be foldably connected to the reinforcement panel, and an inner top reinforcement flap can be foldably connected to the reinforcement panel. The method further comprises positioning the inner top reinforcement flap so that the reinforcement panel at least partially overlaps the inner top reinforcement flap, positioning the reinforcement panel relative to the top panel so that the top panel at least partially overlaps the reinforcement panel, and forming an interior of the carton at least partially defined by the plurality of panels. The forming the interior of the carton comprising forming an open-ended sleeve.

Other aspects, features, and details of the present disclosure can be more completely understood by reference to the following detailed description of exemplary embodiments taken in conjunction with the drawings and from the appended claims.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank according to an exemplary embodiment of the disclosure.

FIG. 2 is an interior plan view of a partially assembled carton according to the exemplary embodiment of the disclosure.

FIG. 3 is a plan view of a partially assembled carton that is further assembled according to the exemplary embodiment of the disclosure.

FIG. 4 is an plan view of a partially assembled carton that is further assembled according to the exemplary embodiment of the disclosure.

FIG. 5 is a perspective view of an open-ended sleeve according to the exemplary embodiment of the disclosure.

FIG. 6 is a perspective view of a partially closed end of the partially assembled carton according to the exemplary embodiment of the disclosure.

FIG. 7 is a perspective view of the interior of the partially assembled carton with a closed end according to the exemplary embodiment of the disclosure.

FIG. 8 is an interior view of the partially erected carton of FIG. 7 with containers loaded therein.

FIG. 9 is a perspective view of the carton according to the exemplary embodiment of the disclosure.

Corresponding parts are designated by corresponding reference numbers throughout the drawings.

### DETAILED DESCRIPTION OF THE EXEMPLARY EMBODIMENTS

The present disclosure generally relates to opening, dispensing, and handling features for cartons that contain articles such as containers, bottles, cans, etc. The articles can be used for packaging food and beverage products, for example. The articles can be made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes beverage containers (e.g., glass beverage bottles) as disposed within the carton embodiments. In this specification, the terms “lower,” “bottom,” “upper” and “top” indicate orientations determined in relation to fully erected and upright cartons.

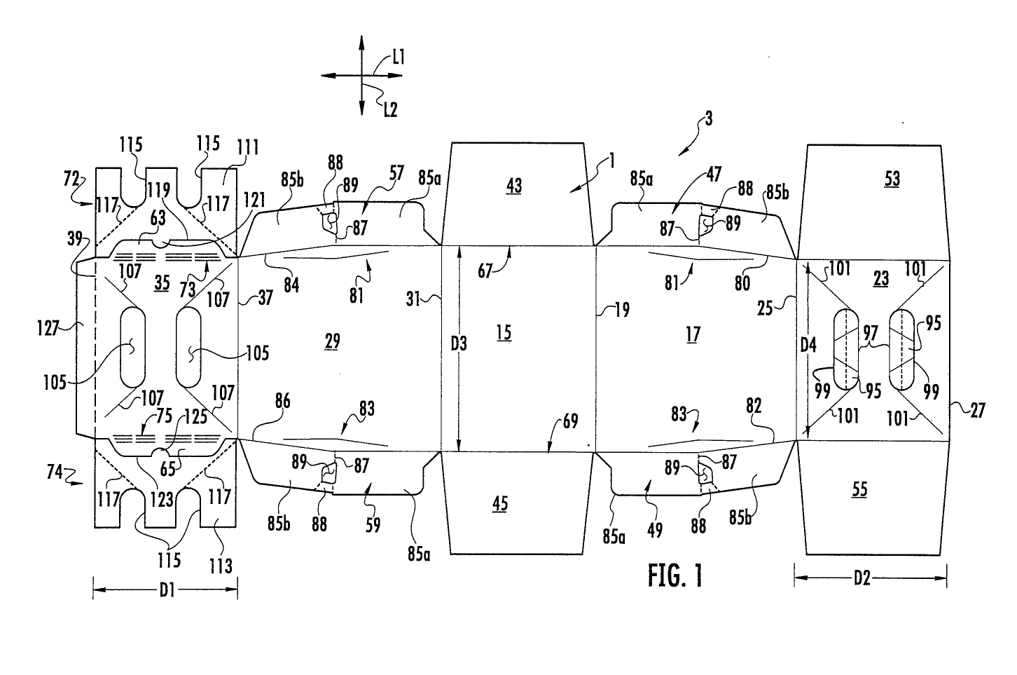

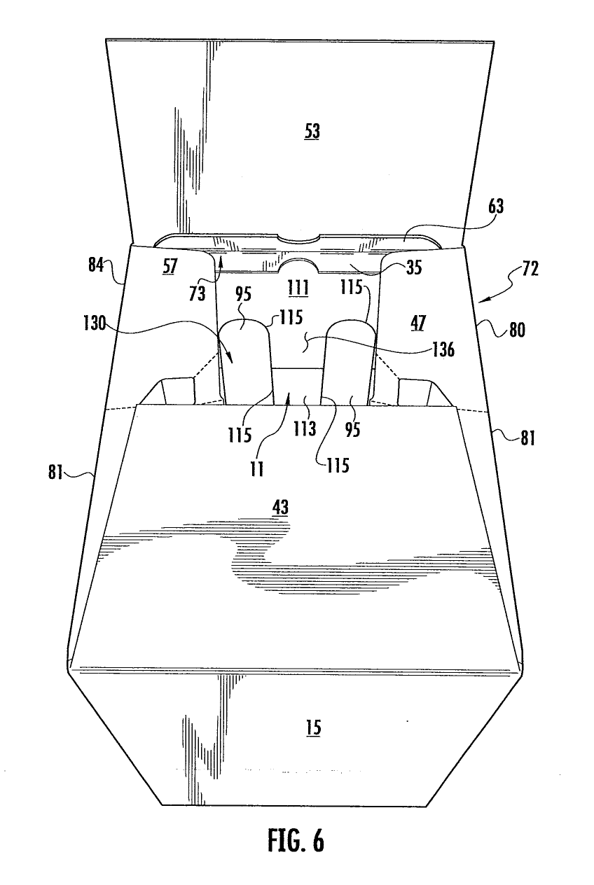

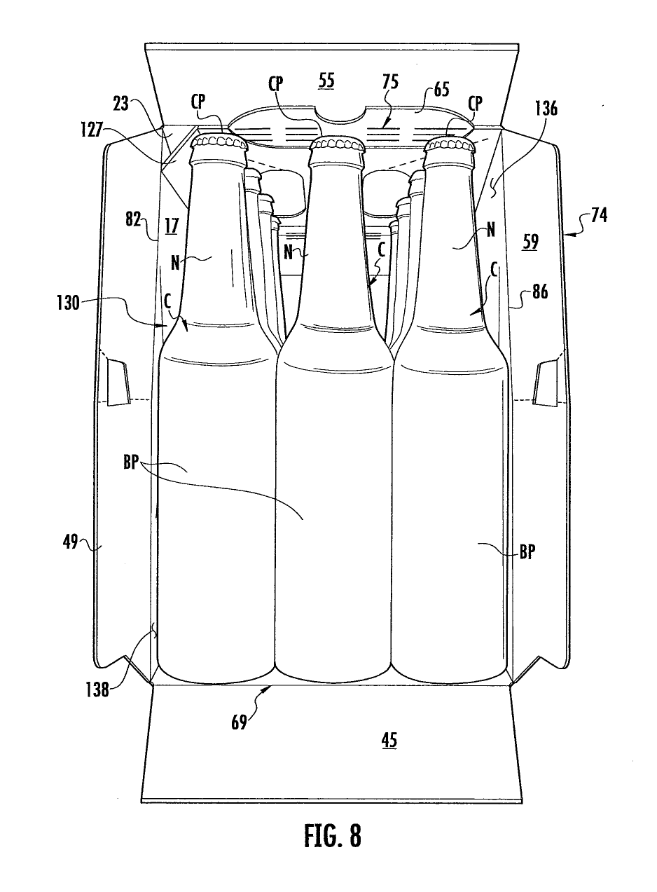

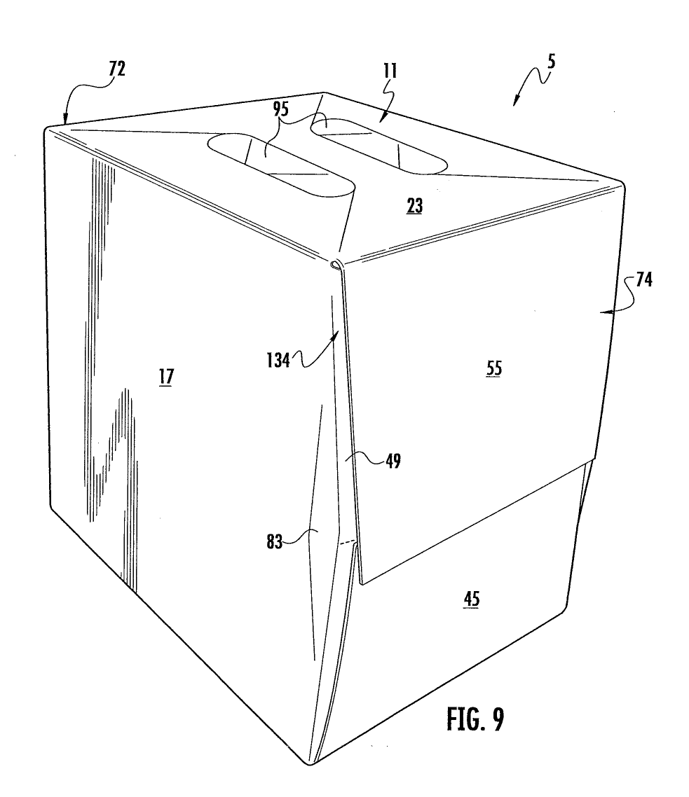

FIG. 1 is a plan view of the exterior side 1 of a blank, generally indicated at 3, used to form a carton 5 (FIG. 9) according to the exemplary embodiment of the disclosure. The carton 5 can be used to house a plurality of articles such as containers C (shown by way of example in FIG. 8). In the illustrated embodiment, the containers C are bottles having a wide bottom portion BP, an upper portion or neck N extending upwardly from the bottom portion BP, and a cap CP at the top of each container C. In the illustrated embodiment, the carton 5 is sized to house twelve containers C in a single layer in a 3×4 arrangement, but it is understood that the carton 5 may be sized and shaped to hold containers C of a different or same quantity in more than one layer and/or in different row/column arrangements (e.g., 1×6, 3×6, 2×6, 2×6×2, 3×4×2, 2×9, 4×3, etc.). The containers C could be otherwise shaped, arranged, and/or configured without departing from the disclosure. For example, the containers C could be beverage cans or other containers. In the illustrated embodiment, the carton 5 includes a handle, generally indicated at 11 (FIGS. 6, 7, and 9), for grasping and carrying the carton.

The blank 3 has a longitudinal axis L1 and a lateral axis L2. In the illustrated embodiment, the blank 3 comprises a bottom panel 15 foldably connected to a first side panel 17 at a first lateral fold line 19, a top panel 23 foldably connected to the first side panel 17 at a second lateral fold line 25, and a second side panel 29 foldably connected to the bottom panel 15 at a third lateral fold line 31. A reinforcement panel 35 is foldably connected to the second side panel 29 at a fourth lateral fold line 37.

The bottom panel 15 is foldably connected to a first bottom end flap 43 and a second bottom end flap 45. The first side panel 17 is foldably connected to a first side end flap 47 and a second side end flap 49. The top panel 23 is foldably connected to a first top end flap 53 and a second top end flap 55. The second side panel 29 is foldably connected to a first side end flap 57 and a second side end flap 59. The reinforcement panel 35 is foldably connected to a first reinforcement end flap 63 and a second reinforcement end flap 65. When the carton 5 is erected, the end flaps 43, 47, 53, 57, 63 close a first end 72 of the carton, and the end flaps 45, 49, 55, 59, 65 close a second end 74 of the carton. In accordance with an alternative embodiment of the present disclosure, different flap arrangements can be used for closing the ends of the carton 5.

The end flaps 43, 47, 53, 57 extend along a first marginal area of the blank 1, and are foldably connected at a first longitudinal fold line 67 that extends along the length of the blank. The end flaps 45, 49, 55, 59 extend along a second marginal area of the blank 1, and are foldably connected at a second longitudinal fold line 69 that also extends along the length of the blank. The longitudinal fold lines 67, 69 may be, for example, substantially straight, or offset at one or more locations to account for blank thickness or for other factors. In the illustrated embodiment, the reinforcement end flaps 63, 65 are foldably connected to the reinforcement panel 35 at respective longitudinal fold lines 73, 75. In the illustrated embodiment, the fold lines 73, 75 comprise a plurality of spaced-apart longitudinal cut lines that create a plurality of distinct and spaced-apart areas of weakening that are wider than the longitudinal fold lines 67, 69, which can be single crease lines, for example. Alternatively, the fold lines 73, 75 could be a single crease line or other form of weakening without departing from the disclosure.

In the illustrated embodiment, the blank 3 includes two diamond-shaped corners, generally indicated at 81, at the first end 72 of the carton 5 and two diamond-shaped corners 83 at the second end 74 of the carton. The corners 81, 83 allow respective side panels 17, 29 and side end flaps 47, 57, 49, 59 to angle inwardly toward the interior of the carton 5. Each of the side end flaps 47, 49, 57, 59 can include a lower portion 85a, which can extend generally perpendicularly from the bottom panel 15 in the carton 5 (FIG. 9), and an upper portion 85b, each of which can extend inwardly from the respective lower portion 85a to the top panel 23 and the reinforcement panel 35 in the carton 5 (FIG. 9). The upper portions 85b of the first and second side end flaps 47, 49 can be foldably connected to the first side panel 17 along respective oblique segments 80, 82 extending from respective corners of the top panel 23 to a longitudinally-extending portion of the respective longitudinal fold lines 67, 69. Similarly, the upper portions 85b of the first and second side end flaps 57, 59 can be foldably connected to the second side panel 29 along respective oblique segments 84, 86 extending from respective corners of the reinforcement panel 35 to a longitudinally-extending portion of the respective longitudinal fold lines 67, 69. The top panel 23 can be shorter than the bottom panel 15 in the lateral direction L2 so that some or all of each end of the carton can be angled inwardly. Each of the top portions 85b can be connected to the respective bottom portion 85a at a fold line 87 and by a foldably-connected web 88, defining a cutout 89. The webs 88 and cutouts 89 can help the top portion 85b to easily angle inwardly with respect to the bottom portions 85a when forming the carton 5.

As shown in FIG. 1, the blank includes handle features for forming the handle 11 of the carton 5. The handle features include two handle flaps 95 foldably connected to the top panel 23 at lateral fold lines 97. The handle flaps 95 are separable from the top panel 23 along curved cut or tear lines 99 so that the handle flaps can fold along the lateral fold lines 97 into or out of the carton 5 and form handle openings in the top panel 23. The top panel includes oblique fold lines 101 extending from a respective cut line 99 that allow the top panel to flex when the carton 5 is grasped and carried by the handle 11. In the illustrated embodiment, the reinforcement panel 35 includes two elongate openings 105 and oblique fold lines 107 extending from the openings. The openings 105 are part of the handle features for forming the handle 11 and are positioned to receive the handle flaps 95 when the carton 5 is erected from the blank 3. The oblique fold lines 107 in the reinforcement panel 35 are positioned to be overlapped by the oblique fold lines 101 in the top panel 23 when the carton 5 is erected from the blank 3. The handle 11 and/or the oblique fold lines 101, 107 could be otherwise shaped, arranged, configured, or omitted without departing from the disclosure. For example, the handle flaps 95 can be in the reinforcement panel 35 and the openings 105 can be in the top panel 23, or both the top panel 23 and the reinforcement panel 35 can have handle flaps 95 or openings 105.

As shown in FIG. 1, the reinforcement panel 35 can include a first inner top reinforcement flap 111 foldably connected to the reinforcement panel 35 at the longitudinal fold line 67 and a second inner top reinforcement flap 113 foldably connected to the reinforcement panel 35 at the longitudinal fold line 69. The first and second inner top reinforcement flaps 111, 113 each can include handle cutouts 115 and oblique fold lines 117. The handle cutouts 115 are part of the handle features for forming the handle 11 and are positioned to generally align with the handle openings 105 in the reinforcement panel 35 and receive the handle flaps 95. The oblique fold lines 117 in the inner top reinforcement flaps 111, 113 are positioned to be overlapped by the oblique fold lines 107 in the reinforcement panel 35 when the carton 5 is erected from the blank 3. An opening or a cut line 119 can extend between the first reinforcement end flap 63 and the first inner top reinforcement flap 111, forming a rounded tab 121, and an opening or cut line 123 can extend between the second reinforcement end flap 65 and the second inner top reinforcement flap 113, forming a rounded tab 125. The inner top reinforcement flaps 111, 113 are separable from the respective reinforcement end flaps 63, 65 along the respective cut lines 119, 123. The inner top reinforcement flaps 111, 113 could be otherwise shaped, arranged, configured, or omitted without departing from the disclosure. For example, the cut lines 119, 123 alternatively can be tear lines.

In the illustrated embodiment, a reinforcement side flap 127 can be foldably connected to the reinforcement panel 35 at a lateral fold line 39. The length of the reinforcement panel 35 between the longitudinal fold lines 67, 69 is generally similar to the length (D4) of the top panel 23 so that the longitudinal fold lines 67, 69 in the top panel 23 generally overlap the fold lines 73, 75 in the reinforcement panel 35 when the carton 5 is erected from the blank. The width (D1) of the reinforcement panel 35 between lateral fold lines 37 and 39 is generally smaller than the width (D2) of the top panel 23 between the lateral fold line 25 and the laterally-extending free edge 27 of the top panel 23 in the illustrated embodiment. In the assembled carton 5, the reinforcement side flap 127 can extend from the top panel 23 to the side panel 17 at an angle to provide a third taper in the interior of the carton 5 proximate the top panel 23 in addition to the tapered portions of the closed ends 72, 74. The reinforcement panel 35, the reinforcement end flaps 63, 65, the inner top reinforcement flaps 111, 113, and the reinforcing side flap 119 could be otherwise shaped, arranged, and/or configured without departing from the disclosure.

An optional dispenser (not shown) can be included with one or more dispenser panels removably attached to the blank 3 at one or more tear lines extending in any of the panels or end flaps.

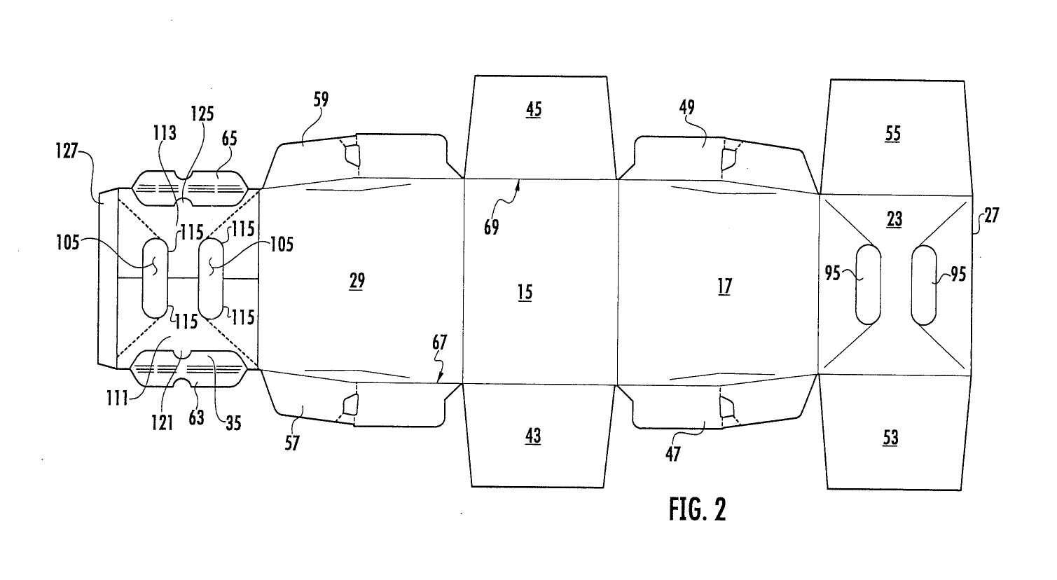

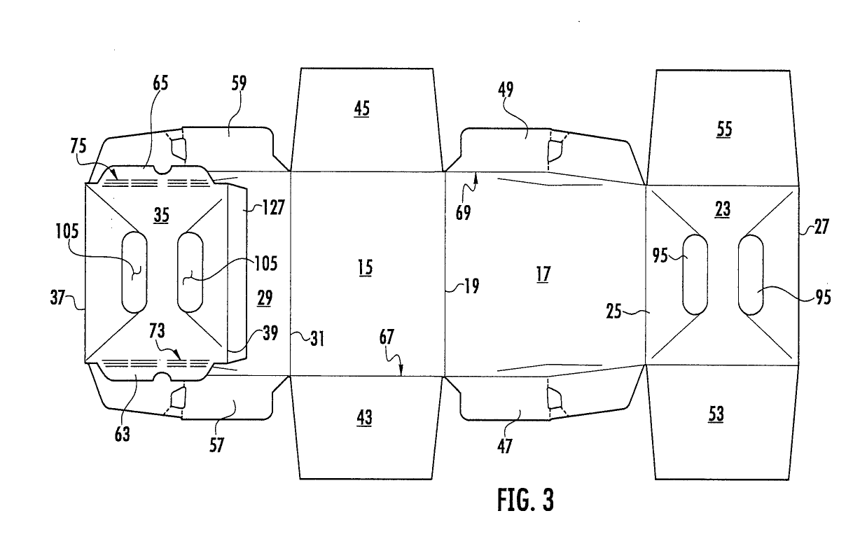

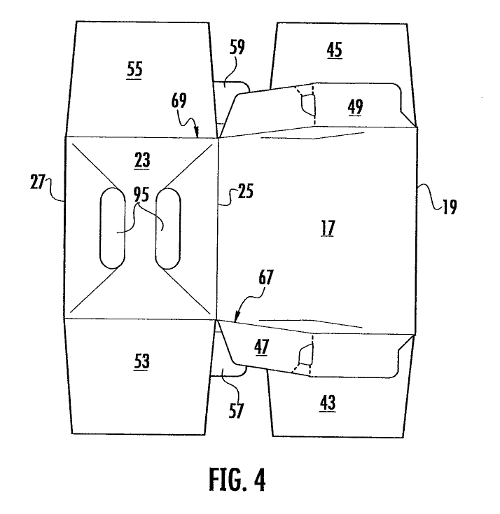

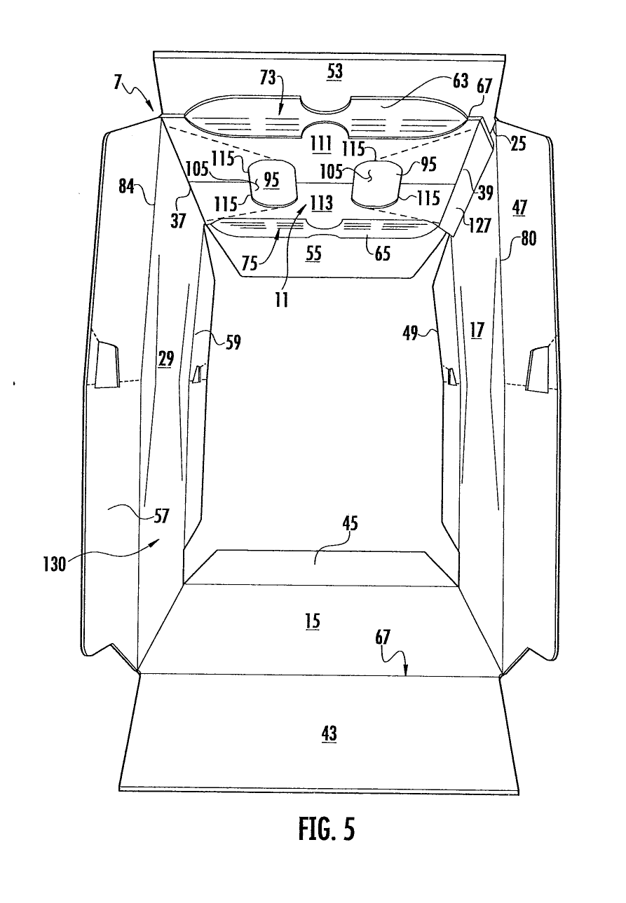

In accordance with the exemplary embodiment, the blank 3 can be erected into the carton 5 by folding the inner top reinforcement flaps 111, 113 along the respective longitudinal fold lines 67, 69 so that the inner top reinforcement flaps are in face-to-face contact with the inner surface of the reinforcement panel 35 and the handle cutouts 115 are generally aligned with the openings 105 (FIG. 2). As shown in FIGS. 3 and 4, the reinforcement panel 35 can be folded about transverse fold line 37 so that the reinforcement panel 35 and the inner top reinforcement flaps 111, 113 overlap the inner surface of the second side panel 29 (FIG. 3), and the first side panel 17 and top panel 23 can be folded along fold line 19 so that the top panel 23 overlaps the reinforcement panel 35 (FIG. 4). The inner surface of the top panel 23 can be in face-to-face contact with the outer surface of the reinforcement panel 35 so that the handle flaps 95 are generally aligned with the openings 105. At least a portion of each of the weakened regions formed by the fold lines 73, 75 is generally aligned with the portions of the respective longitudinal fold line 67, 69 extending in the top panel 23. The reinforcement panel 35 and the top panel 23 can be glued or otherwise adhesive secured together when the top panel and reinforcement panel are placed into face-to-face contact. Similarly, the inner top reinforcement flaps 111, 113 can be glued in face-to-face contact to the reinforcement panel 35. Further, the top panel 23, the reinforcement panel 35, and the inner top reinforcement flaps 111, 113 can be secured by other attachment mechanisms. The blank can be folded along fold lines 19, 25, 31, 37 to form a partially-erected carton in the form of an open-ended sleeve 7 with an interior 130 (FIG. 5).

When the top panel 23 overlaps the reinforcement panel 35, reinforcement end flaps 63, 65 are placed into face-to-face contact with a respective top end flap 53, 55. In the illustrated embodiment, the reinforcement end flaps 63, 65 are free to fold independently of the top end flaps 53, 55. In an alternative embodiment, the reinforcement end flaps 63, 65 and the respective top end flaps 53, 55 can be adhesively secured by an adhesive or they can be secured by other attachment mechanisms.

As shown in FIG. 5, the reinforcement side flap 127 extends from the lateral fold line 39, extending along the inner surface of the top panel 23, to abut the inner surface of the first side panel 17 at an angle. In the illustrated embodiment, the upper portions N of the containers C are narrower than the bottom portions BP, and the angled reinforcement side flap 127 provides a tapered side proximate the top panel 23 to help secure the upper portions N in the reduced area between the reinforcement side flap 127 and the generally vertical second side panel 29 (FIG. 8).

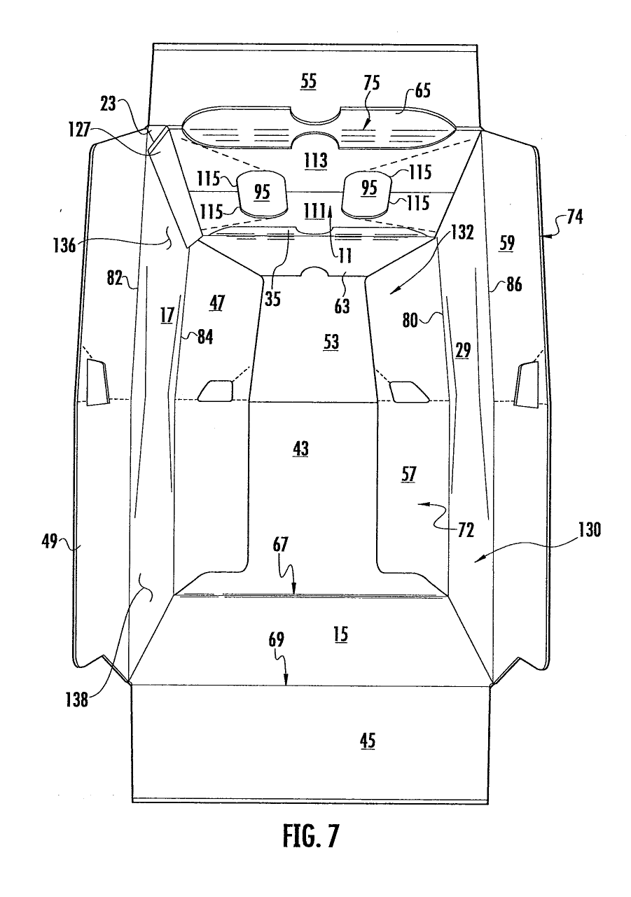

In the illustrated embodiment, the first end 72 of the carton 5 is closed by respectively overlapping and adhering the end flaps 43, 47, 53, 57, 63 (FIGS. 6 and 7). In one embodiment, the side end flaps 47, 57 can be folded along the longitudinal fold line 67 inwardly over the open end 72, and the bottom end flap 43 can be folded upwardly along the longitudinal fold line 67 to overlap the lower portions 85a of the side end flaps 47, 57 (FIG. 6). Similarly, the top panel 53 can fold downwardly along the longitudinal fold line 67 to overlap the upper portions 85b of the side end flaps 47, 57 and the bottom end flap 43. As the top end flap 53 is folded downwardly, the top end flap 53 can contact the exterior surface of the reinforcement end flap 63 and fold the reinforcement end flap 63 downwardly along the fold line 73 to overlap the upper portions 85b of the side end flaps 47, 57. The closed first end 72 is shown in FIG. 7.

As shown in FIG. 8, the containers C can be loaded into the sleeve 7 with the bottom portions BP of the containers being supported by the bottom panel 15 and the caps CP of the containers being disposed proximate the reinforcement panel 35 and the inner top reinforcement flaps 111, 113. The inner top reinforcement flaps 111, 113, the reinforcement panel 35, and the top panel 23 provide a reinforced, three-ply top wall of the carton 5 that prevents the caps CP from penetrating, or otherwise damaging the top wall of the carton, and strengthens the top wall for carrying the carton 5 by the handle 11.

The second end 74 of the carton 5 can be closed similarly to the first end 72 by respectively overlapping the end flaps 45, 49, 55, 59, 65 (FIG. 9). Other closing and loading sequences may be used without departing from the disclosure. For example, the containers can be loaded into the carton 5 before closing the ends of the carton or after closing the second end 74.

As shown in FIGS. 8 and 9, the carton 5 of the present disclosure can be shaped to hold containers such as bottles in an upright position such that the wider bottom portions BP of the containers C are supported by the bottom panel 15 and the narrower top portions N of the bottles are in contact with or adjacent to the overlapped top panel 23, reinforcement panel 35, and inner top reinforcement flaps 111, 113. In the illustrated embodiment, the bottom portion of the first end 72, including the bottom portions 85a of the side end flaps 47, 57 and the bottom end flap 43, is generally vertical and contacts or is closely adjacent the bottom portions BP of the containers C in the row adjacent the first end 72. Similarly, the bottom portion of the second end 74, including the bottom portions 85a of the side end flaps 49, 59 and the bottom end flap 45, is generally vertical and contacts, or is closely adjacent, the bottom portions BP of the containers C in the row adjacent the second end 74. Further, the bottom portions of the side panels 17, 29 contact, or are closely adjacent, the bottom portions BP of the containers C in the respective columns adjacent the side panels 17, 29, which are generally vertical in the illustrated embodiment. As shown in FIG. 1, the bottom panel 15 has a lateral dimension or length D3 that is greater than a lateral dimension or length D4 of the top panel 23. Accordingly, in the illustrated embodiment, the closed ends 72, 74 can include inwardly tapered portions 132, 134.

In the illustrated embodiment, the tapered portion 132 of the first end 72, including the upper portions 85b of the side end flaps 47, 57, the top end flap 53, and the reinforcement end flap 63, angles inwardly from the lower portion of the first end 72 to the top panel 23 and the reinforcement panel 35 at the oblique segments 80, 84 of the longitudinal fold line 67. Similarly, the tapered portion 134 of the second end 74, including the upper portions 85b of the side end flaps 49, 59, the top end flap 55, and the reinforcement end flap 65, angles inwardly from the lower portion of the first end 74 to the top panel 23 and the reinforcement panel 35 at the oblique segments 82, 86 of the longitudinal fold line 69. The tapered portions 132, 134 of the first and second ends 72, 74 each contacts, or is closely adjacent, the upper portions N of the containers C in the rows respectively adjacent the first and second ends 72, 74. In addition, the diamond-shaped corners 81, 83 of the carton 5 can help allow the tapered portions 132, 134 of the ends 72, 74 to be angled inwardly so that the carton 5 is more narrow at the top than at the bottom at each end 72, 74. Accordingly, at least the tapered portions 132, 134 of the ends 72, 74 and the reinforcement side flap 127 form a narrowed upper interior portion 136 that helps restrain the upper portions N of the containers C above a wider lower interior portion 138 that helps restrain the bottom portions BP of the containers in the interior 130 of the carton 5.

The narrowing of the length of the carton 5 from the bottom to the top at the ends 72, 74 provides two points of contact of the ends with the containers to hold both the top portions N and the bottom portions BP of the containers C in a relatively fixed position to restrict movement of the containers in the carton. Accordingly, the carton 5 of the illustrated embodiment is tapered on two sides externally. Internally, the reinforcement side flap 127 provides a third side to the taper proximate the corner formed at the lateral fold line 25 connecting the top panel 23 to the first side panel 17. Accordingly, the carton 5 effectively is tapered on three sides internally.

Alternatively, the carton 5 of the present disclosure could be a three- or four-sided taper carton where the bottom panel 15 is both longer and wider in the directions L1, L2 than the top panel 23. A three-sided taper carton, for example, can have ends 72, 74 angling inwardly as described above and the upper portion of the second side panel 29 could be angled inwardly. Accordingly, the second side panel 29, the reinforcement side flap 127, and the closed ends 72, 74 would cooperate to form the upper interior portion 136 of the carton, and effectively provide a four-sided taper carton in the interior 130 of the carton 5.

An externally four-sided taper carton would have at least the upper portions of the ends 72, 74 and side panels 17, 29 angling inwardly to help restrain the upper portions N of the containers C. The reinforcement side flap 127 can cooperate with the angled side panels 17, 29 to further narrow the top of the interior of the carton 5. Alternatively, the reinforcement side flap 127 can be in face-to-face contact with the angled side panel 17, or the reinforcement side flap 127 could be omitted. Further, the carton 5 could alternatively be without any sides or ends that taper and all four of the ends 72, 74 and side panels 17, 29 could be substantially perpendicular to the bottom panel 15 without departing from the scope of the disclosure.

In a further alternative, the reinforcement panel 35 can include a second reinforcement side flap (not shown) foldably connected to the reinforcement panel at a lateral fold line proximate the second side panel 29. The second reinforcement side flap can extend at an angle from the reinforcement panel to abut the second side panel 29 similarly to the first reinforcement side flap 127 in relation to the first side panel 17. The second reinforcement side flap can be combined with variations of the carton 5 including where one or more of the side panels 17, 29 and closed ends 72, 74 taper inwardly, or where all of the sides and the ends are substantially perpendicular to the bottom panel 15.

In general, the blank may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blank may then be coated with a varnish to protect information printed on the blanks. The blank may also be coated with, for example, a moisture barrier layer, on either or both sides of the blanks. The blank can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding a plurality of containers, the carton comprising:
a plurality of panels extending at least partially around an interior of the carton, the plurality of panels comprising a bottom panel, a first side panel foldably connected to the bottom panel, a top panel foldably connected to the first side panel, a second side panel foldably connected to the bottom panel, and a reinforcement panel foldably connected to the second side panel, the top panel at least partially overlapping the reinforcement panel;
a reinforcement side flap foldably connected to the reinforcement panel; and
an inner top reinforcement flap foldably connected to the reinforcement panel, the reinforcement panel at least partially overlapping the inner top reinforcement flap.

2. The carton of claim 1, further comprising at least two end flaps respectively foldably attached to respective panels of the plurality of panels, the at least two end flaps being at least partially overlapped with respect to one another to thereby at least partially form a closed end of the carton, wherein the at least two end flaps comprise a top end flap foldably connected to the top panel.

3. The carton of claim 2, wherein the at least two end flaps further comprise a reinforcement end flap foldably connected to the reinforcement panel, the reinforcement end flap being at least partially in face-to-face contact with an interior surface of the top end flap.

4. The carton of claim 3, wherein the at least two end flaps further comprise a first side end flap foldably connected to the first side panel and a second side end flap foldably connected to the second side panel, and the reinforcement end flap is at least partially in face-to-face contact with an exterior surface of each of the first side end flap and the second side end flap.

5. The carton of claim 4, wherein the reinforcement end flap is foldably connected to the reinforcement panel along an area of weakening, and the inner top reinforcement flap is foldably connected to the reinforcement panel along a fold line, the area of weakening being generally aligned with the fold line.

6. The carton of claim 4, further comprising a handle comprising at least one handle feature in the top panel and at least one handle opening in the reinforcement panel, the at least one handle feature being generally aligned with the at least one handle opening, wherein the inner top reinforcement flap comprises at least one handle cutout that is generally aligned with at least a portion of each of the at least one handle feature and the at least one handle opening.

7. The carton of claim 2, wherein the first side panel and the second side panel extend generally perpendicular to the top panel and the bottom panel, and the reinforcement side flap extends in an oblique direction from the reinforcement panel to the first side panel.

8. The carton of claim 7, wherein the top panel comprises a first length and the bottom panel comprises a second length, the first length being less than the second length, and at least a portion of the closed end of the carton is angled inwardly adjacent the top panel.

9. The carton of claim 1, further comprising a handle comprising a first handle feature and a second handle feature in the top panel and a third handle feature and a fourth handle feature in the reinforcement panel, the third handle feature being generally aligned with the first handle feature and the fourth handle feature being generally aligned with the second handle feature, wherein the inner top reinforcement flap comprises a first handle cutout and a second handle cutout, the first handle cutout is generally aligned with at least a portion of the third handle feature in the reinforcement panel and the first handle feature in the top panel, and the second handle cutout is generally aligned with at least a portion of the fourth handle feature in the reinforcement panel and the second handle feature in the top panel.

10. The carton of claim 9, wherein:
the inner top reinforcement flap is a first inner top reinforcement flap foldably connected to the reinforcement panel at a first end, the first inner top reinforcement flap is in face-to-face contact with a first portion of the reinforcement panel;
the carton further comprises a second inner top reinforcement flap foldably connected to the reinforcement panel at an opposing second end, the second inner top reinforcement flap is in face-to-face contact with a second portion of the reinforcement panel; and
the second inner top reinforcement flap comprises a third handle cutout and a fourth handle cutout, the third handle cutout is generally aligned with a portion of the third handle feature in the reinforcement panel and the first handle feature in the top panel, and the fourth handle cutout is generally aligned with a portion of the fourth handle feature in the reinforcement panel and the second handle feature in the top panel.

11. The carton of claim 10, wherein:
each of the first handle cutout and the second handle cutout is defined in a first free edge of the first inner top reinforcement flap and is generally U-shaped;
each of the third handle cutout and the fourth handle cutout is defined in a second free edge of the second inner top reinforcement flap and is generally U-shaped;
the first free edge of the first inner top reinforcement flap is positioned adjacent the second free edge of the second inner top reinforcement flap; and
the third handle cutout of the second inner top reinforcement flap is generally aligned with the first handle cutout of the first inner top reinforcement flap, and the fourth handle cutout of the second inner top reinforcement flap is generally aligned with the second handle cutout of the first inner top reinforcement flap.

12. A blank for forming a carton for holding a plurality of containers, the blank comprising:
a plurality of panels comprising a bottom panel, a first side panel foldably connected to the bottom panel, a top panel foldably connected to the first side panel, a second side panel foldably connected to the bottom panel, and a reinforcement panel foldably connected to the second side panel, wherein the top panel at least partially overlaps the reinforcement panel in the carton formed from the blank;
a reinforcement side flap foldably connected to the reinforcement panel; and
an inner top reinforcement flap foldably connected to the reinforcement panel, wherein the reinforcement panel at least partially overlaps the inner top reinforcement flap when the carton is formed from the blank.

13. The blank of claim 12, further comprising at least two end flaps respectively foldably attached to respective panels of the plurality of panels, the at least two end flaps for being at least partially overlapped with respect to one another to thereby at least partially form a closed end of the carton formed from the blank, wherein the at least two end flaps comprise a top end flap foldably connected to the top panel.

14. The blank of claim 13, wherein the at least two end flaps further comprise a reinforcement end flap foldably connected to the reinforcement panel, the inner top reinforcement flap is separable from the reinforcement end flap along a cut line, and the reinforcement end flap is for being at least partially in face-to-face contact with an interior surface of the top end flap in the carton formed from the blank.

15. The blank of claim 14, wherein the at least two end flaps further comprise a first side end flap foldably connected to the first side panel and a second side end flap foldably connected to the second side panel, and the reinforcement end flap is for being at least partially in face-to-face contact with an exterior surface of each of the first side end flap and the second side end flap.

16. The blank of claim 15, wherein the reinforcement end flap is foldably connected to the reinforcement panel along an area of weakening, and the inner top reinforcement flap is foldably connected to the reinforcement panel along a fold line, the area of weakening being generally aligned with the fold line.

17. The blank of claim 15, further comprising a handle comprising at least one handle feature in the top panel and at least one handle opening in the reinforcement panel, wherein the at least one handle feature is for being generally aligned with the at least one handle opening in the carton formed from the blank, the inner top reinforcement flap comprises at least one handle cutout that is for being generally aligned with at least a portion of each of the at least one handle feature and the at least one handle opening in the carton formed from the blank.

18. The blank of claim 15, wherein:
the first side end flap and the second side end flap are foldably connected to the respective first side panel and second side panel along a fold line, at least a portion of the fold line extending in a generally longitudinal direction;
the top panel comprises a first length and the bottom panel comprises a second length, the first length being less than the second length; and
the fold line comprises a first oblique segment extending from the top panel and a second oblique segment extending from the reinforcement panel.

19. The blank of claim 12, further comprising handle features for forming a handle in the carton formed from the blank, the handle features comprising a first handle feature and a second handle feature in the top panel, a third handle feature and a fourth handle feature in the reinforcement panel, and a first handle cutout and a second handle cutout the inner top reinforcement flap.

20. The blank of claim 19, wherein:
the inner top reinforcement flap is a first inner top reinforcement flap foldably connected to the reinforcement panel at a first end, the first inner top reinforcement flap is for being in face-to-face contact with a first portion of the reinforcement panel in the carton formed from the blank;
the carton further comprises a second inner top reinforcement flap foldably connected to the reinforcement panel at an opposing second end, the second inner top reinforcement flap is for being in face-to-face contact with a second portion of the reinforcement panel in the carton formed from the blank; and
the handle features further comprise a third handle cutout and a fourth handle cutout in the second inner top reinforcement flap.

21. The blank of claim 20, wherein:
each of the first handle cutout and the second handle cutout is defined in a first free edge of the first inner top reinforcement flap and is generally U-shaped;
each of the third handle cutout and the fourth handle cutout is defined in a second free edge of the second inner top reinforcement flap and is generally U-shaped;
the first free edge of the first inner top reinforcement flap is positioned adjacent the second free edge of the second inner top reinforcement flap in the carton formed from the blank; and
the third handle cutout of the second inner top reinforcement flap is for being generally aligned with the first handle cutout of the first inner top reinforcement flap in the carton formed from the blank, and the fourth handle cutout of the second inner top reinforcement flap is for being generally aligned with the second handle cutout of the first inner top reinforcement flap in the carton formed from the blank.

22. A method of forming a carton comprising:
obtaining a blank comprising a plurality of panels comprising a bottom panel, a first side panel foldably connected to the bottom panel, a top panel foldably connected to the first side panel, a second side panel foldably connected to the bottom panel, and a reinforcement panel foldably connected to the second side panel, a reinforcement side flap foldably connected to the reinforcement panel, and an inner top reinforcement flap foldably connected to the reinforcement panel;
positioning the inner top reinforcement flap so that the reinforcement panel at least partially overlaps the inner top reinforcement flap;
positioning the reinforcement panel relative to the top panel so that the top panel at least partially overlaps the reinforcement panel; and
forming an interior of the carton at least partially defined by the plurality of panels, the forming the interior of the carton comprising forming an open-ended sleeve.

23. The method of claim 22, wherein:
the blank further comprises a plurality of end flaps respectively foldably attached to respective panels of the plurality of panels, the plurality of end flaps comprising a top end flap foldably connected to the top panel, a reinforcement end flap foldably connected to the reinforcement panel, a first side end flap foldably connected to the first side panel, and a second side end flap foldably connected to the second side panel; and
the method further comprises forming an at least partially closed end of the open-ended sleeve by at least partially overlapping the plurality of end flaps with respect to one another, the at least partially overlapping the plurality of end flaps comprising positioning the reinforcement end flap at least partially in face-to-face contact with the top end flap and at least partially in face-to-face contact with each of the first side end flap and the second side end flap.

24. The method of claim 23, wherein:
the forming the interior of the carton comprises positioning the first side panel and the second side panel to extend generally perpendicular to the top panel and the bottom panel and positioning the reinforcement side flap to extend in an oblique direction from the reinforcement panel to the first side panel; and
at least a portion of the at least partially closed end of the carton is angled inwardly adjacent the top panel.

25. The method of claim 22, wherein:
the blank further comprises handle features for forming a handle, the handle features comprising a first handle feature and a second handle feature in the top panel, a third handle feature and a fourth handle feature in the reinforcement panel, and a first handle cutout and a second handle cutout the inner top reinforcement flap;
the positioning the reinforcement panel relative to the top panel comprises generally aligning the third handle feature with the first handle feature and the fourth handle feature with the second handle feature;
the positioning the inner top reinforcement flap comprises generally aligning the first handle cutout with at least a portion of the third handle feature in the reinforcement panel and the first handle feature in the top panel and generally aligning the second handle cutout with at least a portion of the fourth handle feature in the reinforcement panel and the second handle feature in the top panel.

26. The method of claim 25, wherein:
the inner top reinforcement flap is a first inner top reinforcement flap foldably connected to the reinforcement panel at a first end, and the positioning the inner top reinforcement flap comprising positioning the first inner top reinforcement flap in face-to-face contact with a first portion of the reinforcement panel;
the blank further comprises a second inner top reinforcement flap foldably connected to the reinforcement panel at an opposing second end, the second inner top reinforcement flap comprising a third handle cutout and a fourth handle cutout; and
the method further comprises positioning the second inner top reinforcement flap in face-to-face contact with a second portion of the reinforcement panel so that the third handle cutout is generally aligned with a portion of the third handle feature in the reinforcement panel and the first handle feature in the top panel, and so that the fourth handle cutout that is generally aligned with a portion of the fourth handle feature in the reinforcement panel and the second handle feature in the top panel.
